(19) United States
(12) Patent Application Publication
(10) Pub. No.: US 2018/0320418 A1
(43) Pub. Date: Nov. 8, 2018

(54) Striker Unit for a Motor Vehicle

(71) Applicant: Huf Hülsbeck & Fürst GmbH & Co. KG, Velbert (DE)

(72) Inventor: Jorg Berghahn, Velbert (DE)

(21) Appl. No.: 15/972,989

(22) Filed: May 7, 2018

(30) Foreign Application Priority Data
May 8, 2017 (EP) 17169882.2

(51) Int. Cl. E05B 77/38; E05B 85/04; E05B 83/18; E05B 77/40

(52) U.S. Cl. CPC E05B 77/38; E05B 77/40; E05B 83/18; E05B 85/045

(57) ABSTRACT

A striker unit for a motor vehicle includes a base plate that can be connected to a body part of the motor vehicle, a retaining bracket, a bracket plate for mounting the retaining bracket, and an elastic element that is arranged between the base plate and the bracket plate. The base plate and the bracket plate can additionally be connected to one another through a second and/or third positive locking and/or frictional connection.

### CROSS REFERENCE TO RELATED APPLICATIONS

This application claims priority to EP Patent Application No. 17169882.2, filed May 8, 2017. The disclosure of this prior application is considered part of the disclosure of this application and is hereby incorporated by reference in its entirety.

### FIELD

The present disclosure relates to a striker unit for a motor vehicle, having a base plate that can be connected to a body part of the motor vehicle, a retaining bracket, a bracket plate for mounting the retaining bracket, and an elastic element that is arranged between the base plate and the bracket plate, wherein the bracket plate can be connected to the base plate by means of the elastic element through a first positive locking and/or integral connection to one another.

### BACKGROUND

A striker unit for a motor vehicle is known from the prior art that includes a base plate and a bracket plate. The bracket plate is designed for mounting a retaining bracket, and the base plate is connected to a body part of the motor vehicle. Arranged between the bracket plate and the base plate is an elastic element that is provided for positive locking connection of the base plate to the bracket plate. The prior art motor vehicle has a tailgate or a hatch, such as a liftgate, with a motor vehicle lock that includes a rotary latch and a pawl. When the liftgate of the motor vehicle is closed, the rotary latch, in particular a jaw of the rotary latch, is in contact with or engaged with the retaining bracket. During travel of the vehicle, the liftgate can experience vibrations, so that the bracket plate is subjected to a force, in particular in the y-direction and/or the z-direction. As a result, this leads to an undesirable tilting motion of the bracket plate, which causes undesirable noises.

The object of the invention is therefore to provide a striker unit that improves comfort for a user, in particular during travel.

### SUMMARY

According to the invention, the base plate and the bracket plate can additionally be connected to one another through at least a second, and preferably through a third, positive locking and/or frictional connection. The at least one additional positive locking and/or frictional connection ensures rattle-free mounting of the bracket plate. It is consequently ensured that the bracket plate remains immobile relative to the base plate in the y-direction and the z-direction, even in the event of high forces acting on the retaining bracket in the in the y-direction and/or the z-direction. This has the result that a door or liftgate, for example, of the motor vehicle likewise remains essentially immobile, and, consequently, undesirable rattling noises are reduced in advantageous fashion. A collision of the car body parts, in particular of the liftgate with the body, is advantageously prevented because the dimensions of the gaps between these components remain unchanged in the y-direction and/or the z-direction.

According to one preferred embodiment of the striker unit, provision can be made that both the base plate and the bracket plate are at least partially coated by the elastic element. This has the advantage that the elastic element, in addition to the other connections between the base plate and the bracket plate, additionally holds the base plate and the bracket plate together, in particular within the framework of an integral connection. It can therefore be advantageous for the elastic element to be made of a rubber-like substance in order to ensure a floating mounting of the retaining bracket, in particular in the x-direction. The liftgate is provided with a motor vehicle lock that has at least a rotary latch with a jaw and a pawl. In the closed state of the liftgate, the rotary latch, in particular the jaw, is engaged with the retaining bracket. The floating mounting of the bracket plate, and thus also of the retaining bracket, in the x-direction, which simultaneously also represents the motor vehicle's direction of travel, ensures a decoupling of the liftgate in the x-direction. This is especially important when oscillations of the air column due to motor vibrations or an open sunroof and/or window of the motor vehicle cause a rumbling noise in the passenger compartment. These oscillations are damped by the floating mounting of the retaining bracket, and thus also of the liftgate, as a result bringing about an improved comfort for the user because the noise within the passenger compartment is reduced.

The striker unit can be produced very simply and economically if the second and/or third connections are each implemented by a riveted connection. The riveted connections can be installed easily and quickly, including, in particular, when the base plate and the bracket plate are already coated by the elastic element.

According to another preferred embodiment of the striker unit, provision can be made that the riveted connections each include a sleeve and a stepped pin that forms a frictional and/or positive locking connection with the applicable sleeve. By means of the sleeve and the stepped pin, it is possible to ensure a tight connection between the base plate and the bracket plate that will withstand even high forces. Moreover, assembly of the sleeve and stepped pin can be carried out easily by a worker or a machine. Afterwards, the riveted connection that is implemented by the sleeve and the stepped pin can only be taken apart again using force and tools.

According to another preferred embodiment of the striker unit, provision can be made that the stepped pin has a first end section, in particular disk-shaped end section, that is mounted in a floating manner in an oblong hole arranged in the bracket plate. In this design, the first end section, in particular disk-shaped end section, of the stepped pin is designed to be movable in the x-direction within the oblong hole when a force acts on the retaining bracket in the x-direction. The floating mounting of the bracket plate, and thus also of the retaining bracket, in the x-direction, which simultaneously also represents the motor vehicle's direction of travel, ensures a decoupling of the liftgate and the car body in the x-direction. This has the advantage that the rumbling noise caused by the oscillating air column in the passenger compartment of the motor vehicle is reduced further. Oscillations caused by the vibration of the engine can likewise be successfully insulated.

In order to further reduce the frictional forces between the bracket plate and the stepped pin during movement of the stepped pin in the oblong hole, provision can be made that an air gap is arranged between the first end section of the stepped pin and the bracket plate. In addition, the stepped pin also has a second end section that can be deformed after installation of the stepped pin so that a section, which in particular is disk-shaped, is produced that creates a positive locking connection with the base plate.

The riveted connections of the striker unit can be made to be very secure when the retaining bracket and the riveted connection, in particular the sleeve and the stepped pin, are made of the same material, preferably of a microalloyed steel.

Assembly of the sleeve and the stepped pin can be simplified if the elastic element has, for each riveted connection, a recess or through-hole that serves for passage and/or mounting of the sleeve and/or of the stepped pin.

According to another preferred embodiment of the striker, provision can be made that the sleeve is at least partially coated by the elastic element. This measure ensures that the sleeve is mounted securely and tightly within the elastic element, and movement of the sleeve is precluded. Consequently, the sleeve can oppose compressive forces on the bracket plate, depending on the direction of force.

According to another preferred embodiment of the striker, provision can be made that the sleeve rests against the base plate and is located a distance from the bracket plate, wherein an air gap is arranged between the bracket plate and the sleeve. Because of the air gap, it is ensured that the bracket plate can move in the x-direction relative to the stepped pin and to the base plate without the sleeve touching the bracket plate.

In order to ensure a uniform distribution of force on the bracket plate, provision can be made that the riveted connections are located at a distance from the retaining bracket, wherein the distance between the retaining bracket and the first connection and the distance between the retaining bracket and the second connection are essentially identical.

According to an alternative embodiment of the striker unit, provision can be made that the second and/or preferably the third connection are each implemented by a clip connection or are each implemented by a snap-in connection. The clip connection and the snap-in connection each have the advantage that the components to be connected, in particular the bracket plate and the base plate, are simple for a worker to connect.

In order to be able to ensure a good and secure connection between the base plate and the bracket plate, provision can be made that the base plate has at least a first hole and preferably a second hole. In addition, provision can be made that the bracket plate has at least a first connecting section and preferably a second connecting section. The time required to manufacture the striker unit can be shortened if at least the first connecting section is engaged with the first hole, and preferably the second connecting section is engaged with the second hole, in the assembled state of the striker unit.

According to another embodiment of the striker unit, provision can be made that at least a first snap-in and/or latching element and preferably a second snap-in and/or latching element is provided, wherein the first snap-in and/or latching element is arranged on the first connecting section, and preferably the second snap-in and/or latching element is arranged on the second connecting section. The first snap-in and/or latching element and preferably the second snap-in and/or latching element contribute to simplified assembly of the bracket plate with the base plate. The first snap-in and/or latching element and preferably the second snap-in and/or latching element are preferably made of plastic. Both the bracket plate and the base plate are preferably made of a metal. In order to ensure a rattle-free and stable connection between these two components, it should be possible to connect the two components to one another by means of a press-fit connection, in particular a frictional connection. Since the bracket plate and the base plate have tolerances, it is possible that either the two components may be difficult to connect to one another or air gaps may arise at the connecting sections that can result in the two components rattling against one another. The snap-in and/or latching elements, which preferably are made of plastic, are arranged on the first connecting section, and preferably on the second connecting section, of the bracket plate. Since the snap-in and/or latching element is more elastic than the metal bracket plate, a compensation of tolerances can therefore occur. So that the snap-in and/or latching element can be securely arranged on the bracket plate, provision is preferably made that at least the first connecting section has a first latch opening, and preferably the second connecting section has a second latch opening. In this design, the first snap-in and/or latching element can have a first latching section, preferably a first latching clip and/or a second latching clip, and preferably the second snap-in and/or latching element can have a second latching section, preferably a third latching clip and/or a fourth latching clip, wherein the first latching clip is engaged with the first latch opening and preferably the second latching clip is engaged with the second latch opening. The more latching clips are used, the more stably the applicable snap-in and/or latching element is arranged on the bracket plate. Moreover, the applicable snap-in and/or latching element can easily be installed on the bracket plate and can be removed again if necessary.

The retaining bracket can be securely connected to the rotary latch of the motor vehicle lock if the retaining bracket is U-shaped in design, and a first leg and a second leg of the retaining bracket can each be connected to the bracket plate, in particular using the riveted connection or the clip connection or the snap-in connection. In this design, in particular in the case of a riveted connection, the end of each leg of the U-shaped retaining bracket can be designed as a stepped pin.

According to another preferred embodiment of the striker unit, provision can be made that the retaining bracket can be connected to a body part of a rear section of the motor vehicle.

### DRAWINGS

The striker unit according to the invention is described in detail on the basis of two exemplary embodiments. The figures show:

FIG. 1 a striker unit according to the invention in an oblique perspective view from above according to a first embodiment,

FIG. 2 the striker unit according to the invention in a view from above according to the first embodiment,

FIG. 3 the striker unit according to the invention in a view from below according to the first embodiment,

FIG. 4 the striker unit according to the invention according to a section A-A in FIG. 3 according to the first embodiment,

FIG. 5 a riveted connection in the un-deformed state according to the first embodiment,

FIG. 6 the riveted connection in the deformed state according to the first embodiment,

FIG. 7 a striker unit according to the invention in an oblique perspective view from above according to a second embodiment,

FIG. 8 the striker unit according to the invention in a view from below according to the second embodiment,

FIG. 9 a bracket plate for the striker unit according to the second embodiment in a view from above,

FIG. 10 the bracket plate for the striker unit according to the second embodiment in a view from below,

FIG. 11 a base plate for the striker unit according to the second embodiment in a view from above,

FIG. 12 the base plate for the striker unit according to the second embodiment in a view from below,

FIG. 13 a snap-in element for the bracket plate for the striker unit according to the second embodiment in a perspective view,

FIG. 14 the snap-in element for the bracket plate for the striker unit according to the second embodiment in another perspective view,

FIG. 15 the bracket plate with the installed snap-in element for the striker unit according to the second embodiment in a perspective view, and

FIG. 16 an elastic element for the striker unit according to the first and/or second embodiment in a perspective view.

### DETAILED DESCRIPTION

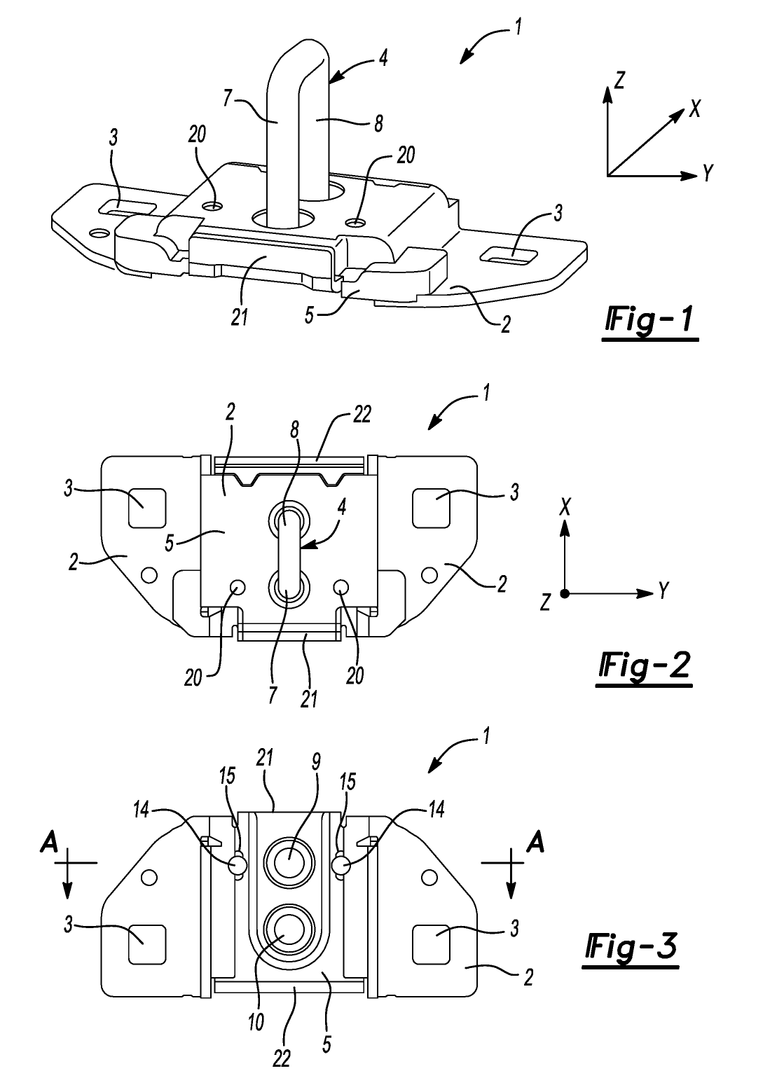

Shown in FIGS. 1 to 4 is a striker element 1 according to the invention for a motor vehicle according to a first embodiment. The striker element 1 has a base plate 2 that can be connected to a body part (not shown in detail) of the motor vehicle, in particular to a body part of the rear section of the motor vehicle. The base plate 2 is provided with two mounting holes 3 used for mounting to the car body. Fasteners, such as rivets or screws, for example, can be passed through these mounting holes 3 in order to produce a frictional and/or positive locking connection between the striker element 1 and the car body. In addition, the striker element 1 includes a retaining bracket 4 that engages with a motor vehicle lock arranged on a liftgate, in particular with a rotary latch of the motor vehicle lock, when the liftgate is closed. Moreover, the striker element 1 also has a bracket plate 5, which is used for mounting the retaining bracket 4, and an elastic element 6, which is arranged at least partially between the base plate 2 and the bracket plate 5.

The elastic element 6 serves to form the first positive locking and/or integral connection, wherein the base plate 2 and the bracket plate 5 are connected to one another by means of the elastic element 6. The integral connection between the base plate 2 and the bracket plate 5 is ensured by an adhesive bond that can be produced by vulcanization of the elastic element 6. In this case, both the base plate 2 and the bracket plate 5 are at least partially coated by the elastic element 6.

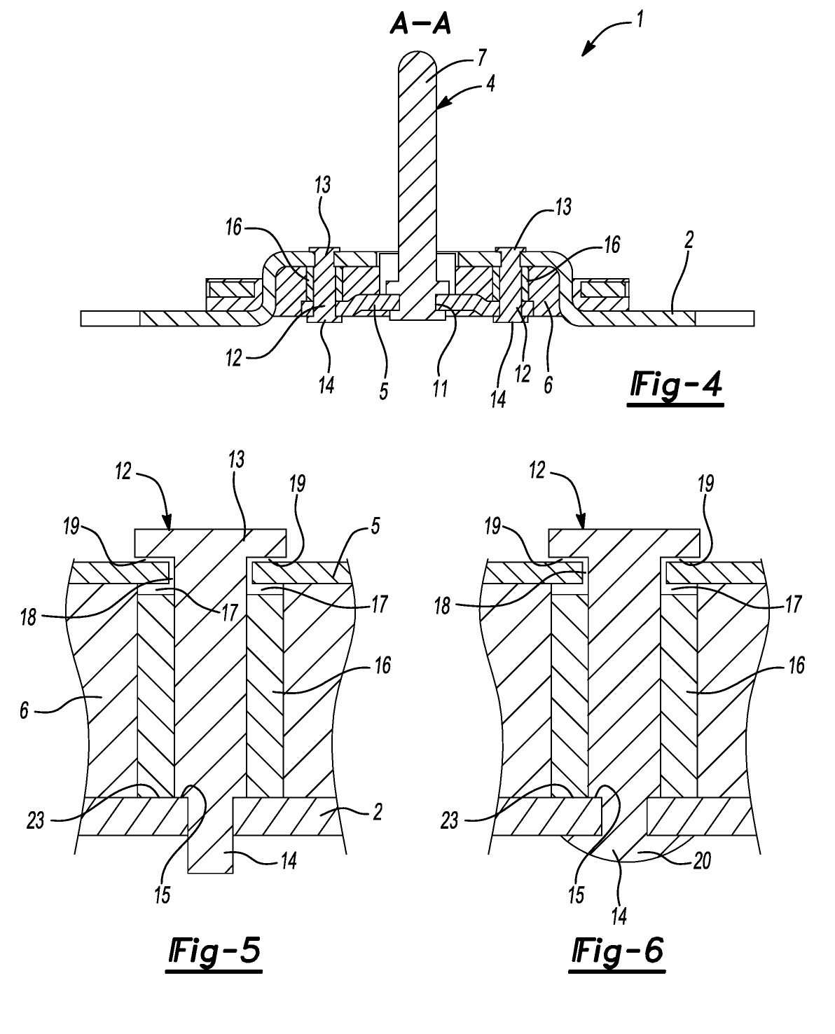

The retaining bracket 4 is U-shaped in design and has a first leg 7 and a second leg 8 that are connected to the bracket plate 5 in a positive locking manner and/or frictionally by means of a riveted connection. In this case, designing the ends of the legs 7, 8 in the form of stepped pins suggests itself in order to ensure a secure and tight connection between the bracket plate 5 and the retaining bracket 4, as is clearly visible in FIG. 4.

The leg 7 in the form of a stepped pin is passed through a first retaining bracket hole 11, and the leg 8 in the form of a stepped pin is passed through a retaining bracket hole that is not shown in detail. In order to produce the riveted connection between the base plate 2 and the retaining bracket 4, one end of the leg 7 or 8 is deformed into a first retaining bracket disk 9 or a second retaining bracket disk 10 so that a tight and permanent frictional and/or positive locking connection is produced between the retaining bracket 4 and the bracket plate 5.

In order to prevent a movement of the bracket plate 5 relative to the base plate 2 in the y-direction and/or in the z-direction, in advantageous fashion the bracket plate 5 and the base plate 2 are connected to one another through an additional second, and preferably a third, positive locking and/or frictional connection. In this design, the second and the third positive locking connections are each implemented as a riveted connection. In the present exemplary embodiment, the first and the second riveted connections are identical in structural design for cost reasons. This is why the same reference characters are used below for identical individual parts of the two riveted connections.

The structure of the riveted connection is described in detail below. The riveted connection includes a stepped pin 12, which is shown in detail in its un-deformed state in FIG. 5 and in its deformed state in FIG. 6. The purpose of the stepped pin 12 is to produce a frictional and/or positive locking connection of the base plate 2 to the bracket plate 5. The stepped pin 12 has a first end section 13, in particular disk-shaped in design, and a second end section 14. Arranged between the two end sections 13 and 14 is a step 15, which, in particular, is likewise disk-shaped in design. In the region between the base plate 2 and the bracket plate 5, the stepped pin 12 is at least partially enclosed by a sleeve 16, which can also serve as a guide during insertion of the stepped pin 12. The sleeve 16 rests against the base plate 2 and is arranged at a distance from the bracket plate 5, wherein a first air gap 17 is arranged between the bracket plate 5 and the sleeve 16. The sleeve 16 is coated by the elastic element 6 so that this sleeve 16 is mounted securely, tightly, and so as to be free of motion.

In addition, an oblong hole 18 is arranged in the bracket plate 5, which serves to guide the stepped pin 12 in the x-direction. For this reason, a second air gap 19 is arranged between the disk-shaped end section 13 and the bracket plate 5 in order to ensure movement of the stepped pin 12 in the x-direction. Consequently, the retaining bracket 4 is mounted in a floating manner in the x-direction. If forces arise in the x-direction of the retaining bracket 4, then the bracket plate 5, which is connected to the retaining bracket 4, can move in the x-direction relative to the base plate 2 because of the floating mounting of the stepped pin 12 in the oblong hole 18. As this occurs, the elastic element 6 is compressed by being pressed against a first wall 21 or a second wall 22 of the base plate 2, depending on the direction of force. The elastic element 6 consequently also serves as a damping element.

During assembly of the striker unit 1, the sleeve 16 is coated with the elastic element 6, which preferably is implemented as an elastomer. After that, the stepped pin 12 is first inserted into the bracket plate 5 until the step 15 strikes an inner wall 23 of the base plate 2. After that, the second end section 14 of the stepped pin 12 is deformed with a tool so that a section 20, in particular a disk-shaped section, is produced, which forms a positive locking connection with the base plate 2. Now, if forces arise in the y-direction and/or in the z-direction, which are produced, for instance, during travel of the motor vehicle because of travel-induced movements, then, for example, the sleeve 16 located on the left side of the retaining bracket 4 is subjected to compressive stress and the stepped pin 12 located on the right side of the retaining bracket 4 is subjected to tensile stress with respect to the forces. Depending on the action of force, this may also be reversed, so that the sleeve 16 located on the left side of the retaining bracket 4 is subjected to tensile stress, and the stepped pin 12 located on the right side of the retaining bracket 4 is subjected to compressive stress. Because of irregular motions or oscillations, during travel an interaction will occur between the distribution of the compressive forces and the tensile forces on the sleeve 16 or on the stepped pin 12. As a result, however, it is ensured that a tilting of the bracket plate 5 relative to the base plate 2 is prevented.

The elastic element 6 is preferably made of a rubber-like substance in order to ensure a floating mounting of the retaining bracket 4, in particular in the x-direction. The liftgate is provided with the motor vehicle lock that has at least the rotary latch with a jaw and a pawl. In the closed state of the liftgate, the rotary latch, in particular the jaw, is engaged with the retaining bracket 4. The floating mounting of the bracket plate 5, and thus also of the retaining bracket 4, in the x-direction, which simultaneously also represents the motor vehicle's direction of travel, ensures a decoupling of the liftgate in the x-direction. This is especially important when oscillations of the air column due to an open window cause a rumbling noise in the passenger compartment of the motor vehicle. These oscillations are damped by the floating mounting of the retaining bracket 4, and thus also of the liftgate, as a result bringing about an improved comfort for the user because the noise within the passenger compartment is reduced. The sleeve 16 and the stepped pin 12 therefore connect the base plate 2 and the bracket plate 5.

As can be seen clearly in FIGS. 1 to 4, the two riveted connections are located at a distance from the retaining bracket 4, wherein the distance between the retaining bracket 4 and the first positive locking connection and the distance between the retaining bracket 4 and the second positive locking connection are essentially identical. Moreover, the retaining bracket 4 and the riveted connections, in particular the sleeve 16 and the stepped pin 12, are made of the same material, preferably of a microalloyed steel.

The striker unit 1 described above can be used in a liftgate as well as in a door of the motor vehicle.

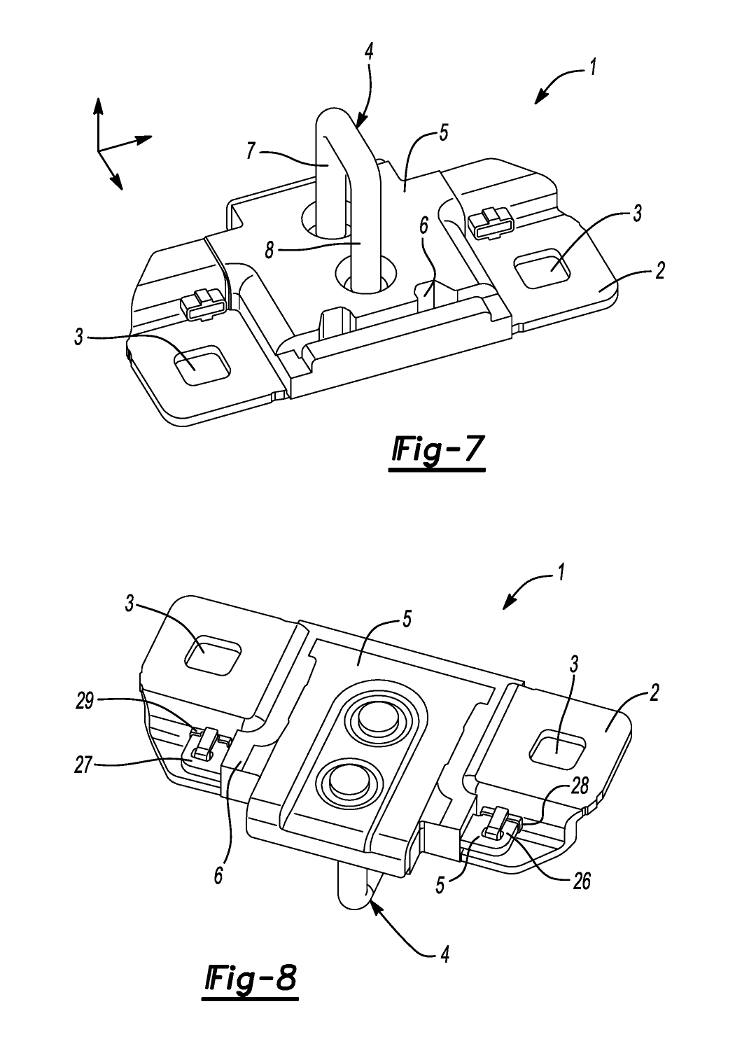

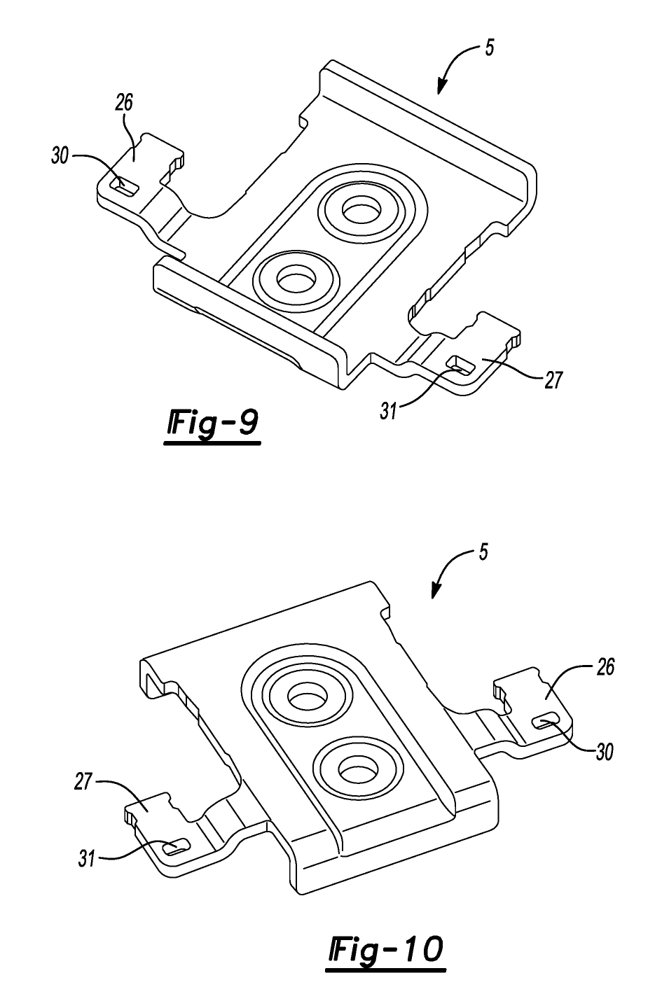

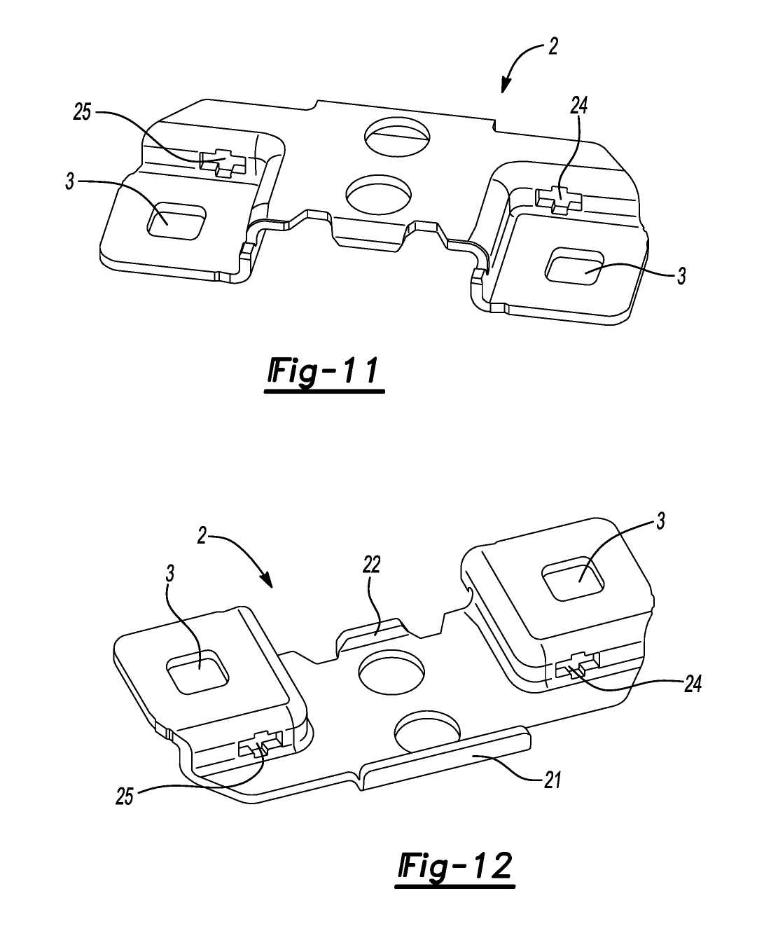

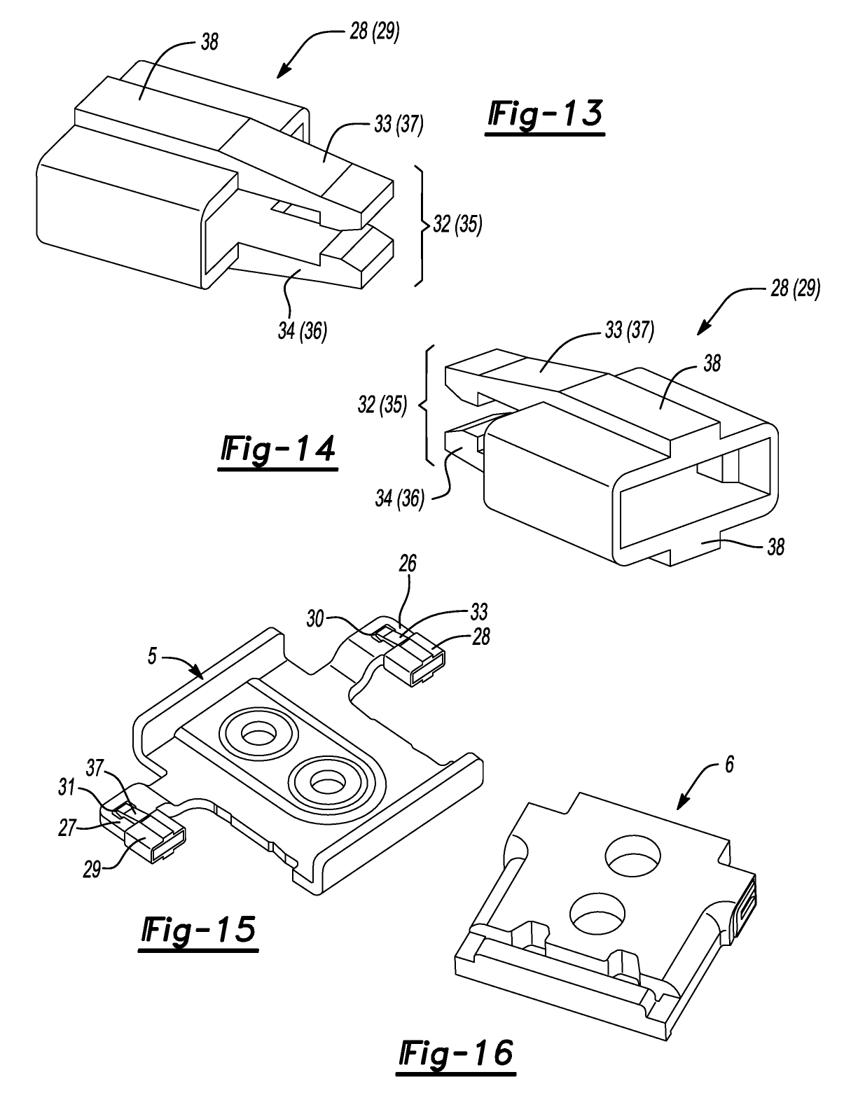

A striker unit 1 according to a second embodiment is visualized in FIGS. 7-15. The same reference characters for components that were already described in the first exemplary embodiment are used in the second exemplary embodiment.

Only the essential differences of the striker unit 1 according to the second embodiment, in particular with regard to the frictional and/or positive locking connection of the bracket plate 5 to the base plate 2, are discussed. The function of the striker unit remains essentially unchanged.

In FIG. 7, the striker unit 1 is shown in which the base plate 2 and the bracket plate 5 can additionally be connected to one another through at least a second, and preferably through a third, positive locking and/or frictional connection.

The second and/or preferably the third connection are each implemented by a snap-in connection. Alternatively, a snap-in and/or clip connection would also be possible. To this end, the base plate 2 has at least a first hole 24 and preferably a second hole 25. The bracket plate 5, on the other hand, has at least a first connecting section 26 and preferably a second connecting section 27. In the assembled state of the striker unit 1, at least the first connecting section 26 is engaged with the first hole 24, and preferably the second connecting section 27 is engaged with the second hole 25. At least a first snap-in element 28 and preferably a second snap-in element 29 serves this purpose, wherein the first snap-in element 28 is arranged on the first connecting section 26, and preferably the second snap-in element 29 is arranged on the second connecting section 27. The snap-in elements 28, 29 have the same structural design. For secure and reliable arrangement of the snap-in elements 28, 29, at least the first connecting section 26 has a first latch opening 30, and preferably the second connecting section 27 has a second latch opening 31.

In this design, the first snap-in element 28 includes a first latching section 32, preferably a first latching clip 33 and/or a second latching clip 34, and preferably the second snap-in element 29 has a second latching section 35, preferably a third latching clip 36 and/or a fourth latching clip 37, wherein the first latching clip 33 and the second latching clip 34 are engaged with the first latch opening 30, and preferably the third latching clip 36 and the fourth latching clip 37 are engaged with the second latch opening 31.

It is likewise possible to replace at least one snap-in element 28, 29 with a snap-in and/or latching element. In this case, the snap-in and/or latching element would additionally be designed with latching members that interlock with the first hole 24 and/or the second hole 25 in order to connect the bracket plate 5 even more securely and tightly to the base plate 2.

The snap-in elements 28, 29 each include guide elements 38, whose purpose is to simplify arranging the bracket plate 5 in the first or second hole 24, 25. The guide elements 38 are each designed as extensions of the latching clips 33, 34, 36, 37.

FIG. 16 shows the elastic element 6 in detail, which can alternatively be designed as a plastic pad. It may be used for the first embodiment of the striker unit 1 as well as for the second embodiment of the striker unit 1.

What is claimed is:

1. A striker unit for a motor vehicle, comprising:
a base plate that can be connected to a body part of the motor vehicle,
a retaining bracket,
a bracket plate for mounting the retaining bracket, and
an elastic element that is arranged between the base plate and the bracket plate,
wherein the bracket plate can be connected to the base plate by means of the elastic element through a first positive locking and/or integral connection to one another, and
wherein the base plate and the bracket plate can additionally be connected to one another through at least a second, and preferably through a third, positive locking and/or frictional connection.

2. The striker unit according to claim 1, wherein both the base plate and the bracket plate are at least partially coated by the elastic element.

3. The striker unit according to claim 1, wherein the second and/or third connections are each implemented by a riveted connection.

4. The striker unit according to claim 3, wherein the riveted connections each include a sleeve and a stepped pin that forms a frictional and/or positive locking connection with the applicable sleeve.

5. The striker unit according to claim 4, wherein the stepped pin has a first end section, in particular a disk-shaped end section, that is mounted in a floating manner in an oblong hole arranged in the bracket plate.

6. The striker unit according to claim 5, wherein a second air gap is arranged between the first end section of the stepped pin and the bracket plate.

7. The striker unit according to at least one of claim 3, wherein the retaining bracket and the riveted connection, in particular the sleeve and the stepped pin, are made of the same material, preferably of a microalloyed steel.

8. The striker unit according to claim 4, wherein the elastic element has, for each riveted connection, a recess or through-hole that serves for passage and/or mounting of the sleeve and/or of the stepped pin.

9. The striker unit according to claim 4, wherein the sleeve is at least partially coated by the elastic element.

10. The striker unit according to claim 4, wherein the sleeve rests against the base plate and is located a distance from the bracket plate, wherein a first air gap is arranged between the bracket plate and the sleeve.

11. The striker unit according to claim 2, wherein the riveted connections are located at a distance from the retaining bracket, wherein the distance between the retaining bracket and the first connection and the distance between the retaining bracket and the second connection are essentially identical.

12. The striker unit according to claim 1, wherein the second and/or preferably the third connection are each implemented by a clip connection or are each implemented by a snap-in connection.

13. The striker unit according to claim 12, wherein the base plate has at least a first hole and preferably a second hole.

14. The striker unit according to claim 12, wherein the bracket plate has at least a first connecting section and preferably a second connecting section.

15. The striker unit according to one of claim 12, wherein, in the assembled state of the striker unit, at least the first connecting section is engaged with the first hole, and preferably the second connecting section is engaged with the second hole.

16. The striker unit according to one of claim 12, wherein at least a first snap-in and/or latching element and preferably a second snap-in and/or latching element is provided, wherein the first snap-in and/or latching element is arranged on the first connecting section, and preferably the second snap-in and/or latching element is arranged on the second connecting section.

17. The striker unit according to one of claim 12, wherein at least the first connecting section has a first latch opening, and preferably the second connecting section has a second latch opening.

18. The striker unit according to one of claim 12, wherein the first snap-in and/or latching element has a first latching section, preferably a first latching clip and/or a second latching clip, and preferably the second snap-in and/or latching element has a second latching section, preferably a third latching clip and/or a fourth latching clip, wherein the first latching clip and/or the second latching clip is engaged with the first latch opening and preferably the third latching clip and/or the fourth latching clip is engaged with the second latch opening.

19. The striker unit according to at least one of claim 1, wherein the retaining bracket is U-shaped in design, and a first leg and a second leg of the retaining bracket can each be connected to the bracket plate in particular using the riveted connection or the clip connection or the snap-in connection.
